(19) United States
(12) Patent Application Publication
(10) Pub. No.: US 2016/0350420 A1
(43) Pub. Date: Dec. 1, 2016

(54) RESOURCE DIRECTORY

(71) Applicant: HEWLETT-PACKARD DEVELOPMENT COMPANY, L.P., Houston, TX (US)

(72) Inventors: Jyoti RANJAN, Bangalore (IN); Kanagaraj MANICKAM, Bangalore (IN); Travis S TRIPP, Fort Collins, CO (US)

(21) Appl. No.: 15/114,739

(22) PCT Filed: Mar. 28, 2014
(86) PCT No.: PCT/IN2014/000200

§ 371 Date: Jul. 27, 2016

(51) Int. Cl. G06F 17/30; H04L 29/08

(52) U.S. Cl. CPC G06F 17/30864; H04L 67/16; H04L 67/10

(57) ABSTRACT

In one implementation, a system for providing resource information can comprise a spider engine, a discovery engine, an ontology engine, and a publication engine. The spider engine can crawl a resource provider. The discovery engine can discover a resource of a resource provider. The ontology engine can map the resource to an ontology term. The publication engine can provide the ontology term as part of a resource directory. In another implementation, a method for providing resource information can comprise configuring a crawler with an ontology and an interface associated with a resource provider, crawling a network of storage mechanisms, mapping a resource of the network of storage mechanisms to the ontology, and providing a directory of available resources.

### BACKGROUND

Electronic storage mechanisms are available in many architectural forms and configurations. For example, computers can provide storage for data as block-based storage, file-based storage, or time-based storage. Storage can be offered in physical form, such as a hard drive space on a server device, as well as virtual form, such as storage as a service (“SaaS”). Vendors can provision storage based on the native resources available and provide various storage mechanisms. The various storage mechanisms can vary in storage capabilities.

### BRIEF DESCRIPTION OF THE DRAWINGS

FIGS. 1 and 2 are block diagrams depicting example systems for providing resource information.

FIG. 3 depicts example environments in which various example systems for providing resource information can be implemented.

FIG. 4 depicts example modules used to implement example systems for providing resource information.

FIGS. 5 and 6 are flow diagrams depicting example methods for providing resource information.

### DETAILED DESCRIPTION

In the following description and figures, some example implementations of systems and/or methods for providing resource information are described. Storage media can be offered in various configurations and various capabilities. For example, network storage devices may vary in storage capabilities such as media type, thin provisioning, de-duplication, catching, etc. Examples of media type include hard drive technologies such as advanced technology attachment (“ATA”), Serial ATA (“SATA”), solid state drive (“SSD”); disk technology such as compact disks (“CD”) and digital video disks (“DVD”); flash memory technology; and other mechanical technology such as magnetic tape and optical disk drives. Distributed computing environments provide shared pools of resources herein referred to as a “cloud.”. Cloud providers can offer forms of SaaS with various capabilities based on storage capabilities. As the storage environment becomes disconnected from hardware and enters in to virtual space, such as multiple cloud offerings by a meta-cloud, storage offerings continue to increase in capabilities and terminology. Various naming conventions exist and differ among storage resource providers. Resource providers can provide a template of their available resources per their own classification. As used herein, a template is a set of attributes of a storage resource. However, templates of a first storage provider may not be equivalent to templates of a second storage provider. A cloud storage provider can provider storage attributes that may differ from templates or storage capabilities as described for native resources.

Various examples described below relate to providing resource information based on a common ontology. For example, a first set of terminology used by a first storage provider and a second set of terminology used by a second storage provider can be mapped to a common ontology to describe the resources and/or the storage capabilities. A user can request available resources to orchestrate a storage solution based on a workload of the user. A cloud architect can manage the system by providing information to a crawler of the system. For example, the cloud architect can provide the ontology, the infrastructure relationship of resources, and the crawler configuration including interfaces and resource identification information to the system. These sets of information are discussed in more detail below. By utilizing an intelligent crawler, the resources possibilities of multiple providers can be mapped to storage capabilities to be selected by a user and, thereby, reduce confusion amongst offerings of resource providers.

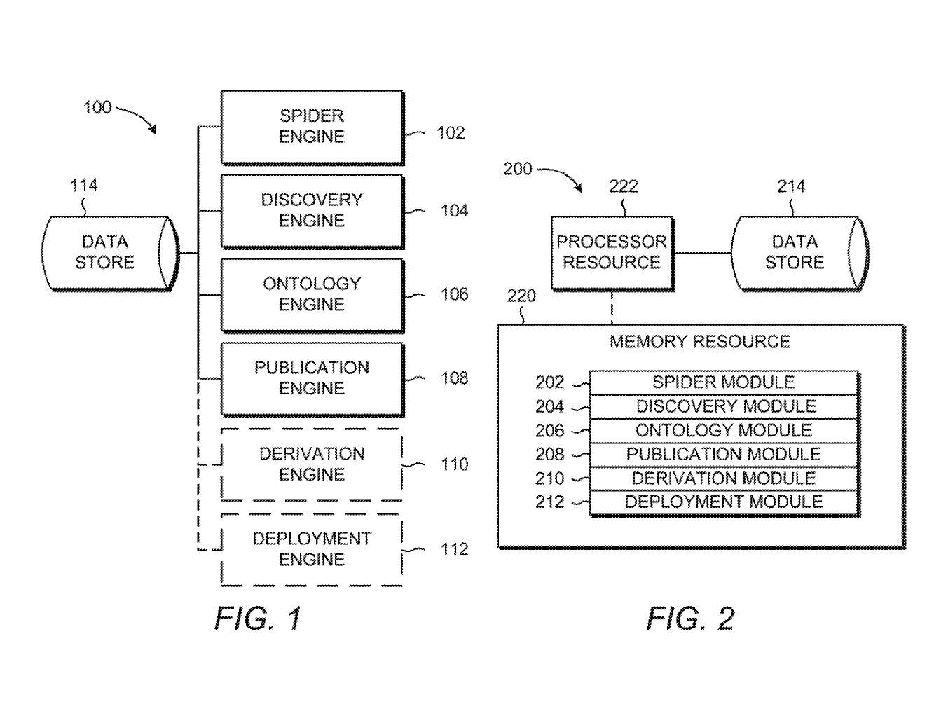

FIGS. 1 and 2 are block diagrams depicting example systems for providing resource information. Referring to FIG. 1, an example system 100 for providing resource information generally comprises a spider engine 102, a discovery engine 104, an ontology engine 106, and a publication engine 108. In general, the system 100 utilizes the engines 102, 104, 106, and 108 to crawl a resource provider to discover available resources and provide the capabilities of the resource providers based on an ontology. As used herein, an ontology represents a set of concepts within the domain of data storage. The ontology includes a shared vocabulary to denote storage types and storage attributes offered by a resource provider. Example attributes can include media type, cache characteristics, and whether redundant array of independent disks (“RAID”) functionality is supported. The ontology can provide a framework of semantic classification to clarify storage capabilities of resources provided among resource providers using various terminologies. A resource, as used herein, represents any appropriate form of storage whether virtual or real. Example resources include such as physical media sources as well as meta-cloud providers, such as providers of multiple clouds and/or vendors. A storage device can create a volume of types of resources available from the storage device.

The system 100 for providing resource information can include a derivation engine 110 and a deployment engine 112 to adapt the system 100 for use in providing appropriate resources for a workload. The terms “include,” “have,” and variations thereof, as used herein, have the same meaning as the term “comprise” or appropriate variation thereof. Furthermore, the term “based on,” as used herein, means “based at least in part on.” Thus, a feature that is described as based on some stimulus can be based only on the stimulus or a combination of stimuli including the stimulus.

The spider engine 102 represents any combination of circuitry and executable instructions to crawl a resource provider. The spider engine 102 can receive a configuration component and configure the crawling functionality based on the configuration component. For example, the spider engine 102 can crawl the resource provider to discover a resource based on a template provided by the resource provider and the resource identification information. The configuration component can contain resource identification information and an interface associated with the resource provider. The interface can be an application programming interface (“API”) or a software development kit (“SDK”) to provide access to a resource provider. The spider engine 102 can use the interface to access the storage mechanisms and/or other location where resource information is located. As used herein, a storage mechanism refers to device for, or manner of, providing storage capacities such as providing memory locations on a server or allocating virtual resources in the cloud. The interface for each resource provider can differ, and the system 100 can maintain a catalog of interfaces to use to crawl resource providers having various interfaces.

The configuration component can be a pluggable component. For example, a crawler can have an interface to receive a component for each storage device and a one-to-one mapping between crawler component and storage device type. This can provide the ability to adopt storage devices in the cloud that vary on API and the ability to dynamically add or remove storage capabilities to the ontology.

The spider engine 102 can be configured to maintain a resource directory. As used herein, the term “maintain” and variations thereof means to add, remove, modify, update, or otherwise manage. The spider engine 102 can maintain the resource directory by crawling interfaces multiple times. For example, the spider engine 102 can at least one of periodically crawl the resource provider to maintain a resource directory and crawl the resource provider on-demand for storage capabilities to maintain the resource directory. The spider engine 102 can contain a catalog of resource providers and interfaces associated with the resource providers. For example, the spider engine 102 can update the resource directory by crawling resource providers based on a catalog of interfaces known to the crawler at a predetermined frequency and/or the spider engine 102 can crawl the resource providers to update the resource directory at the time the resource directory is requested.

The discovery engine 104 represents any combination of circuitry and executable instructions to discover a resource of a resource provider based on the resource identification information. For example, the discovery engine 104 can discover a resource based on a template provided by the resource provider and the resource identification information. The spider engine 102 can locate resource information of a storage provider and the discovery engine 104 can identify the available resources of the storage provider using the resource identification information and the template of the storage provider. For example, the spider engine 102 can locate resource information via an API call at runtime.

The discovery engine 104 can encounter a volume type of a storage device and analyze an attribute of the volume type. For example, the discovery engine 104 can discover a native storage capability and identify the attributes of the native resource based on configuration information from a cloud architect. The discovery engine 104 can understand the native volume type based on the configuration of the storage device. For example, the discovery engine 104 can identify the specific resource for which the storage device is configured. The discover engine 104 can discover native capabilities of a meta-cloud in terms of volume types.

The ontology engine 106 represents any combination of circuitry and executable instructions to map the resource to an ontology term. For example, the ontology engine 106 can map the resource identified by the discovery engine 104 to an ontology based on an infrastructure relationship. The terms of the ontology can be unifications of differing terms of resource providers. The mapping of the resource to the ontology term can be based on an infrastructure relationship identified by a cloud architect. For example, the discovery engine 104 can discover a first template describing raw disk storage and a second template describing cheap storage, where both can map to an ATA drive as a resource based on the ontology and/or can be assigned a storage capability term of “commodity storage” based on the common ontology. The cloud architect can provide the mapping of the ontology term based on the infrastructure relationship with resource identification information.

The ontology engine 106 can maintain an ontology with multiple layers and/or maintain multiple ontologies. For example, the first layer of ontology can be native attribute terminology based on storage specifications, the second layer can be templates terminology based on storage workload, and a third layer can include application terminology based on high-level workload. As discussed further in the description of the deployment engine 112, a resource can be requested at a level of ontology based on the specification for the associated workload and/or a user-provided ontology can map into a particular ontology layer based on the level of ontology of the user-provided ontology. The ontology engine 106 can receive configuration information to allow for storage devices to be recognized by the ontology based on the resource identification information. For example, a crawler having the ontology engine 106 can understand a first level of volume types, such as a device layer, made available by the system 100 and the first level of volume types can be storage device specific. The device layer can have a pluggable architecture. For example, for each supported device, a pluggable component can pull the native volume types per the storage device client at the elemental level or via a storage management client on the storage device.

The publication engine 108 represents any combination of circuitry and executable instructions to provide the ontology term as part of a resource directory. For example, the publication engine 108 can publish a resource directory based on an ontology term associated with the resource available from the resource provider. The resource directory can contain storage information associated with the resource of the resource provider. For example, the resource directory can contain a list of available resources (and/or associated attributes) grouped based on a common ontology term. The publication engine 108 can cause the resource directory to present to a user, such as providing the location of the resource directory. For example, the publication engine 108 can publish a resource directory with the ontology term (representing the resource and/or capability of the resource) to a cloud portal, a website, a database, or other mechanism to provide information to a user. In the example of a cloud portal, an end user can browse through the resource directory and choose a desired resource. The information of the resource directory can be retrieved programmatically to allow resource binding to be done at the time of provisioning the available resource.

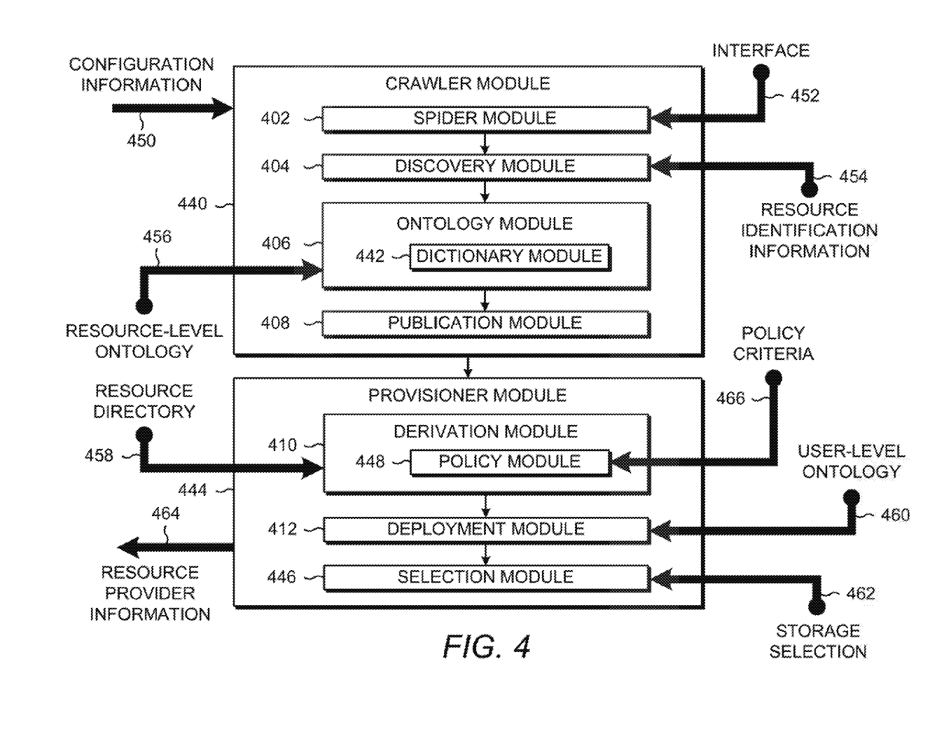

The publication engine 108 can also represent any combination of circuitry and executable instructions to provide a directory of available resources and/or a directory of storage capabilities based on the ontology. Storage capabilities can be the ontology terms of the ontology or other descriptive terms of the attributes of the resources. The publication engine 108 can maintain a dictionary of storage capabilities based on the resource discovered by the discovery engine. The dictionary can contain a plurality of available storage capabilities and associate an available storage capability with a resource and/or a resource provider based on the resource. More detail is provided in the description associated with the dictionary module 444 of FIG. 4.

The derivation engine 110 represents any combination of circuitry and executable instructions to identify a derived capability based on a dictionary of storage capabilities. A derived capability represents a workload specification that is mapable to storage types or templates. For example, an application can a have a security policy that determines the workload specification and a derived capability can classify the available resource based on security capability of the storage mechanism. For another example, a cloud can support backup applications, transaction processing applications, and cache storage as derived capabilities from ontology terms “cheap storage, “RAID based storage,” and “fast SSD-based storage,” respectively.

The derivation engine 110 can identify that an ontology term from the resource directory is associated with a user-provided request for a resource based on the dictionary of storage capabilities. For example, the user can request to execute a workload using a particular storage policy and the derivation engine 110 can identify the storage capabilities that comply with the policy based on the ontology terms.

The derivation engine 110 can maintain a cloud resource inventory including attributes and/or capabilities of each available resource. For example, the resource directory can span across a cloud, which can include multiple data centers located in various geographic locations and the derivation engine 110 can create or otherwise maintain a geographic location attribute, where that geographic location attribute may not have been received by the discovery engine 104. Example derived attributes include location, compliance, and vendor attributes. Various attributes, including attributes derived by the derivation engine 110, can be used to make intelligent binding at the time of provisioning storage. For example, vendor attribute information can be used when a user asks for a storage using a specific vendor and geographic attribute information can be used to provision storage from a region near the physical location of the server to improve throughput. Annotating the native attributes to maintain derived attributes allows for more flexibility and tailoring of storage to a user and/or workload.

The deployment engine 112 represents any combination of circuitry and executable instructions to specify storage using ontology at a given level. For example, the user can desire infrastructure specifications rather than high-level specifications determine resource allocation. The deployment engine 112 can receive an ontology based on the level of specification determined by the user and map the ontology accordingly. For example, the deployment engine 112 can receive a first ontology and map a first ontology to a second ontology, where the second ontology is an ontology specified by a cloud architect. For another example, the first ontology can describe a workload based on an application and the second ontology can include the ontology term associated with the resource. The deployment engine 112 can receive an ontology from a user, such as capabilities associated with the workload and the cloud architect can be configured to map the user-based ontology to the resource ontology of the ontology engine 106. This can allow the crawler to derive standardized or non-standardized storage capabilities from the available resource based on a user's desires or a particular workload or set of workloads.

The deployment engine 112 can receive a deployment profile. The deployment profile can contain guidelines to specify a storage mechanism or group of storage mechanisms. For example, a deployment profile can contain a guideline to use cloud based storage without any vendor affinity. Guidelines can include categories, classifications, ranges, or other proprieties of storage. For example, guidelines of a deployment profile can include levels of performance, average response time, and media redundancy. Guidelines can also be associated with application workloads. The system 100 can provide multiple deployment profiles and/or set a deployment profile as a default for resource provisioning. For example, a bronze storage deployment profile can include cost-optimized performance, 100 ms average response time, no media redundancy, and file backup or archive application workloads; and a silver storage deployment profile can include high performance, 20-40 ms average response time, cost-optimized redundancy, and virtualized application workloads.

The data store 114 can store data used by or otherwise associated with the system 100. Specifically, the data store 114 can store data used or produced by the engines 102, 104, 106, 108, 110, and 112 of the system 100. For example, the data store 114 can include data associated with a resource provider, a crawler configuration, an ontology, a template, and the cloud architect.

FIG. 2 depicts the example system 200 can be implemented on a memory resource 220 operatively coupled to a processor resource 222. The processor resource 222 can be operatively coupled to a data store 214. The data store 214 can be the same as data store 114 of FIG. 1.

Referring to FIG. 2, the memory resource 220 can contain a set of instructions that are executable by the processor resource 222. The set of instructions can implement the system 200 when executed by the processor resource 222. The set of instructions stored on the memory resource 220 can be represented as a spider module 202, a discovery module 204, an ontology module 206, a publication module 208, a derivation module 210, and a deployment module 212. The processor resource 222 can carry out a set of instructions to execute the modules 202, 204, 206, 208, 210, and 212, and/or any other appropriate operations among and/or associated with the modules of the system 200. For example, the processor resource 222 can carry out a set of instructions to receive a configuration from a cloud architect, crawl a resource provider to discover a resource, map the resource to an ontology, and publish a resource directory based on the ontology. The spider module 202, the discovery module 204, the ontology module 206, the publication module 208, the derivation module 210, and the deployment module 212 represent program instructions that when executed function as the spider engine 102, the discovery engine 104, the ontology engine 106, the publication engine 108, the derivation engine 110, and the deployment engine 112 of FIG. 1, respectively.

The processor resource 222 can be one or multiple central processing units (“CPU”) capable of retrieving instructions from the memory resource 220 and executing those instructions. Such multiple CPUs can be integrated in a single device or distributed across devices. The processor resource 222 can process the instructions, serially, concurrently, or in partial concurrence, unless described otherwise herein.

The memory resource 220 and the data store 214 represent a medium to store data utilized by the system 200. The medium can be any non-transitory medium or combination of non-transitory mediums able to electronically store data, such as modules of the system 200 and/or data used by the system 200. For example, the medium can be a storage medium, which is distinct from a transmission medium, such as a signal. The medium can be machine readable, such as computer readable. The memory resource 220 can be said to store program instructions that when executed by the processor resource 222 implements the system 200 in FIG. 2. The memory resource 220 can be integrated in the same device as the processor resource 222 or it can be separate but accessible to that device and the process resource 222. The memory resource 220 can be distributed across devices. The memory resource 220 and the data store 214 can represent the same physical medium or separate physical mediums. The data of the data store 214 can include representations of data and/or information mentioned herein, such as resource identification information, an interface, an ontology, a dictionary, and a directory or other list of available resources and/or available storage providers.

In the discussion herein, the engines 102, 104, 106, 108, 110, and 112 of FIG. 1 and the modules 202, 204, 206, 208, 210, and 212 of FIG. 2 have been described as a combination of circuitry and executable instructions. Such components can be implemented in a number of fashions. Looking at FIG. 2, the executable instructions can be processor executable instructions, such as program instructions, stored on the memory resource 220, which is a tangible, non-transitory computer readable storage medium, and the circuitry can be electronic circuitry, such as processor resource 222, for executing those instructions.

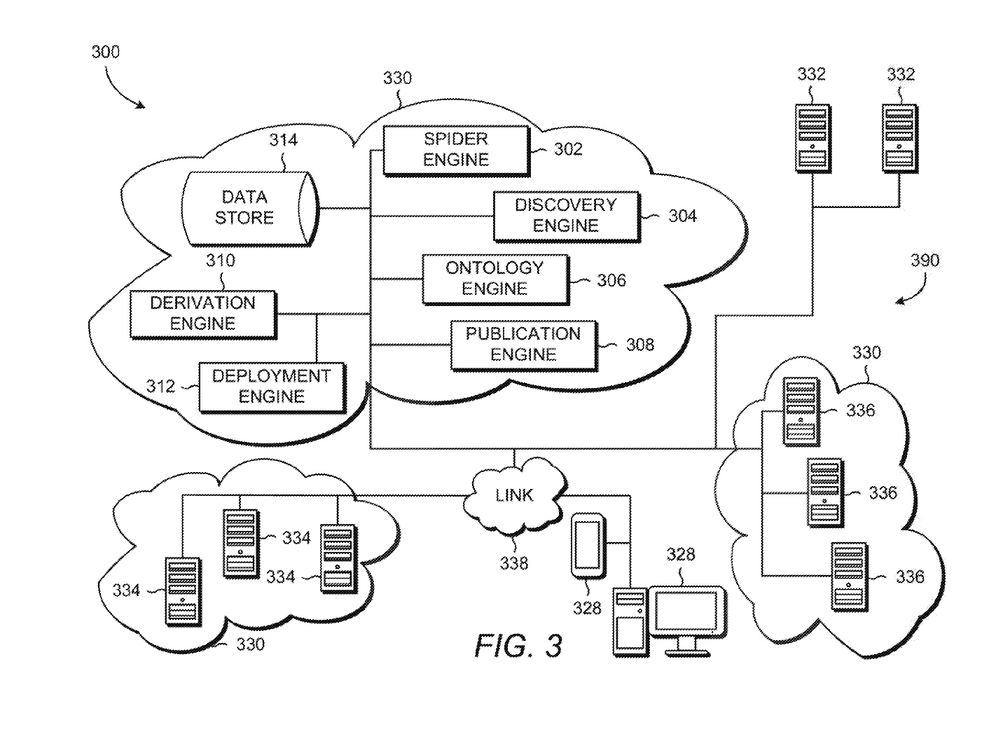

In one example, the executable instructions can be part of an installation package that when installed can be executed by processor resource 222 to implement the system 200. In that example, the memory resource 220 can be a portable medium such as a CD, a DVD, a flash drive, or memory maintained by a computer device, such as service device 332 of FIG. 3, from which the installation package can be downloaded and installed. In another example, the executable instructions can be part of an application or applications already installed. Here, the memory resource 220 can include integrated memory such as a hard drive, an SSD, or the like.

FIG. 3 depicts example environments in which various example systems for providing resource information can be implemented. The example environment 390 is shown to include an example system 300 for providing resource information. The system 300 (described herein with respect to FIGS. 1 and 2) can represent generally any combination of circuitry and executable instructions to provide resource information. The system 300 can include a spider engine 302, a discovery engine 304, an ontology engine 306, a publication engine 308, a derivation engine 310, a deployment engine 312, and a data store 314 that are the same as the spider engine 102, the discovery engine 104, the ontology engine 106, the publication engine 108, the derivation engine 110, the deployment engine 112, and the data store 114 of FIG. 1, respectively, and the associated descriptions are not repeated for brevity.

The example system 300 can be integrated into a compute device, such as a user device 328 or a service device 332, 334, or 336. The system 300 can be distributed across user devices 328, service devices 332, 334, and 336, or a combination of user devices 328 and service devices 332, 334, and 336. The environment 390 can include a cloud computing environment. For example, networks 330 can be distributed networks comprising virtual computing resources. Any appropriate combination of the system 300, user devices 328, and service devices 332, 334, and 336 can be a virtual instance of a virtual shared pool of resources. The engines and/or modules of the system 300 herein can reside and/or execute on the cloud. The example environment 390 can include multiple cloud computing networks, such as networks 330.

The service devices 332, 334, and 336 represent generally any computing devices configured to respond to a network request received from a user device 328, whether virtual or real. For example, networks 330 can be cloud computing environments executing a SaaS model of resources available as service devices 334. For another example, a service device 334 can be a virtual machine of the network 330 providing a service and the user device 328 can be a compute device configured to access the network 330 and receive and/or communicate with the service. The user devices 328 represent generally any compute device configured with a browser or other application to communicate a network request and receive and/or process the corresponding responses. The service devices 332, 334, and 336 represent generally any compute devices configured to respond to a network request received from a user device 328. A service device 332 can include a storage server having an array of hard drives to be associated with a user or a workload for storage purposes, for example.

The system 300 can map the resources of the service devices 332, 334, and 336 to a common ontology and publish the available resources as a resource directory. The system 300 can aggregate the resource information from the networks 330 and service devices 332, 334, and 336 whether virtual or real. For example, service devices 332 can be real physical storage devices offered by a first service provider and defined with a first template, while service devices 334 and 336 can be virtual storage devices offered by a second resource provider and a third resource provider with various storage attributes and capabilities. In that example, the system 300 can crawl the networks 330 of the resource providers, collect the resource information, and publish the capabilities of service devices 332, 334, and 336 in a common way to allow a user to select particular devices for a workload regardless of the device being virtual or real. The resource directory can be used for resource selection and/or resource provider selection by a user of the user device 328 or otherwise cause the user device 328 to present a selection of resources and/or storage capabilities to a user.

A link 338 represents generally one or any combination of a cable, wireless connection, fiber optic connection, or remote connections via a telecommunications link, an infrared link, a radio frequency link, or any other connectors of systems that provide electronic communication. The link 338 can include, at least in part, intranet, the Internet, or a combination of both. The link 338 can also include intermediate proxies, routers, switches, load balancers, and the like.

Referring to FIGS. 1-3, the engines 102, 104, 106, 108, 110, and 112 of FIG. 1, and/or the modules of 202, 204, 206, 208, 210, and 212 of FIG. 2 can be distributed across devices 328, 332, 334, 336, or a combination thereof. The engines and/or modules can complete or assist completion of operations performed in describing another engine and/or module. For example, the spider engine 302 of FIG. 3 can request, complete, or perform the methods and/or operations of the spider engine 302 as well as the discovery engine 304, the ontology engine 306, the publication engine 308, and the derivation engine 310. The engines and/or modules of the system 400 can perform the example methods described in connection with FIGS. 4-6.

FIG. 4 depicts example modules used to implement example systems for providing resource information. The example modules of FIG. 4 generally include a crawler module 440 and a provisioner module 444. As depicted in FIG. 4, the crawler module 440 can include a spider module 402, a discovery module 404, an ontology module 406, and a publication module 408. The provisioner module 444 can include a derivation module 410, a deployment module 412 and a selection module 446. The spider module 402, the discovery module 404, the ontology module 406, the publication module, the derivation module 410, and the deployment module 412 can be the same as the spider module 202, the discovery module 204, the ontology module 206, the publication module 208, the derivation module 210, and the deployment module 212 of FIG. 2, respectively.

A cloud architect can provide configuration information 450 to a crawler module 440. For example, the cloud architect can provide interfaces 452 associated with a set of resource providers, resource identification information 454, and crawling frequency to the crawler module 440. The cloud architect can represents an entity that connects native resources and cloud terminology to align resource categorization with customer's terminology and workload. For example, the cloud architect can represent a management system to deliver, organize, upload, or otherwise manage the resources of a cloud, authorizes actions, and the workload specifications. The cloud architect can construct or otherwise orchestrate the provisioning of service to a user.

The crawler module 440 represents program instructions that when executed function as a combination of circuitry and executable instructions to receive a configuration from a cloud architect. The configuration information can be used to configure the spider module 402, the discovery module 404, the ontology module 406, and the publication module 408. For example, the configuration can include an interface 452 associated with a resource provider, resource identification information 454, and an ontology 456. The spider module 402 can use the interface 452 to communicate with a resource provider. The discovery module 404 can use the resource identification information 454 to identify a resource of the resource provider. The ontology module 406 can map a resource of the resource provider to a resource-level ontology 456. The publication module 408 can create a directory 458 of available resources and format the directory 458 to be presented to a user.

The ontology module 406 can use a dictionary module 442. The dictionary module 442 represents program instructions that when executed function as a combination of circuitry and executable instructions to maintain a dictionary of storage capabilities based on the resource discovered. Storage capabilities can be functional or high-level representations of the attributes of resources of the resource provider. For example, a native resource can be represented as “cheap storage” when described as an ATA drive by the resource provider. The dictionary can contain a plurality of available storage capabilities and definitions of storage capabilities that are mapable to the resource-level ontology 456. For example, the dictionary can associate an available storage capability, such as an ontology term, with a resource provider based on a resource. The dictionary engine 442 can maintain the dictionary of storage capabilities based on the resource discovered by the discovery engine 404.

The provisioner module 444 represents program instructions that when executed function as a combination of circuitry and executable instructions to provide resource provider information 464 based on available resources. The provisioner module 444 can provide a user-oriented interface with the crawler module 440. For example, the storage information collected by the crawler module 440 can be manipulated to allow a user to select a workload and/or storage capability associated with an application via a scripted graphical user interface (“GUI”) of a website. The derivation module 410 can receive a resource directory 458 to identify available storage capabilities. The deployment module 412 can receive a user-level ontology 460 and map the user-level ontology 460 to the resource-level ontology 456. The provisioner module 444 can provide resource provider information 464 based on the workload, the user-level ontology 460, and the directory of available resources 458. For example, the provisioner module 444 can map a directory entry, such as a directory entry selected by a user, with the resource and provide information associated with the resource provider based on the resource.

The derivation module 410 of the provisioner module 444 can include a policy module 448. The policy module 448 represents program instructions that when executed function as a combination of circuitry and executable instructions to assist in identifying suitable resource based on a set of policy criteria 466. For example, the policy module 448 can classify and/or rank attributes and derived attributes based on a policy (described by policy criteria 466). Example policy criteria 466 can include geographic proximity, compliance with a country's data policy, and vendor storage affinity. The policy module 448 can include a filter where a request for a resource can pass through a filter when the system 400 applies the filter logic. Example filters can be associated with a policy criteria 466 or a combination of policy criteria 466. For example, assuming that a user requests storage from the United States region, the geography filter can activate and identify a resource and/or resource provider in the resource directory that is in the United States. In that example, the inactive filters may not adjust the results to provide for selection.

The provisioner module 444 can include a selection module 446. The selection module 446 represents program instructions that when executed function as a combination of circuitry and executable instructions to cause a storage capability to present to a user based on the resource directory 458. For example, the selection module 446 can cause a storage capability to present to a user based on the resource directory 458 and receive a storage selection 462 from a user. The selection module 446 can provide a workload selection, where the workload selection is based on an application and resources associated with the storage capability for the application. The selection module 446 can also offer derived capabilities based on workload. For example, the selection module 446 can cause a selection of a workload, based on an application specification, to present to a user. The user can select a storage selection 462 based on the storage capabilities, derived capabilities, and/or workload presented to the user. The selection module 446 can provide the storage selection 462 to the provisioner module 444 to identify and provide the resource provider information 464 to the user and/or application to produce the workload.

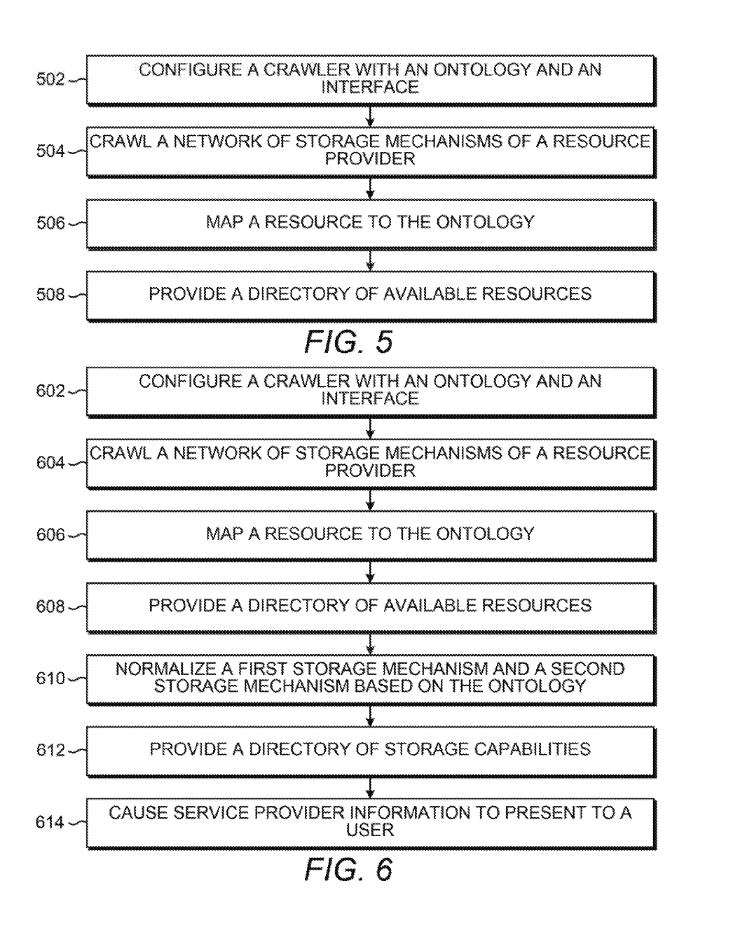

FIGS. 5 and 6 are flow diagrams depicting example methods for providing resource information. Referring to FIG. 5, example methods for providing resource information generally comprise configuring a crawler with an ontology and an interface, crawling a network of storage mechanisms, mapping a resource to the ontology, and providing a directory of available resources.

At block 502, a crawler is configured with an ontology and an interface associated with a resource provider. For example, a cloud architect can maintain a crawler module, such crawler module 440 of FIG. 4, with an ontology and interfaces for communicating with resource providers.

At block 504, a network of storage mechanisms of the resource provider is crawled for a resource. For example, the crawler can discover a resource of the network of storage mechanisms via the interface provided by the cloud architect. The crawler can be configured to periodically crawl the resource providers for available resources based on the interfaces and other configuration information received from the cloud architect. A storage mechanism can be at least one of a virtual resource, such as a cloud compute resource, and a real storage resource, such as hard drive on a service device, such as service device 332 of FIG. 3.

At block 506, a resource of the network of storage mechanisms is mapped to an ontology. The resource can be mapped based on an infrastructure relationship of the resource discovered by the crawler. The crawler can receive the infrastructure relationship from the cloud architect to determine the mapping.

At block 508, a directory of available resources is provided. The directory of available resources can be based on the ontology and a map of the resources of the network of storage mechanisms. The directory can assist a user in selecting a resource or provide a foundation for a directory of storage capabilities that can be provided as discussed in the description of block 612 of FIG. 6.

FIG. 6 includes blocks similar to blocks of FIG. 4 and provides additional blocks and details. In particular, FIG. 6 depicts additional blocks and details generally regarding normalizing storage mechanisms, providing a directory of storage capabilities, and causing resource provider information to present to a user. Blocks 602, 604, 606, and 608 are the same as blocks 502, 504, 506, and 508 of FIG. 5 and their respective descriptions have not been repeated for brevity.

At block 610, a first storage mechanism and a second storage mechanism can be normalized based on the ontology. For example, a first storage mechanism can provide a virtual resource for storage, a second storage mechanism provide a real storage resource, and the first storage mechanism and the second storage mechanism can be normalized based on the ontology. The common ontology among virtual and real storage allows for a plurality of service providers to be offered under a single system, such as system 100.

At block 612, a directory of storage capabilities can be provided. The directory of storage capabilities can be based on the ontology. For example, the entries of the directory of storage capabilities can provide functional representations that map to the entries of the directory of available resources. The directory of storage capabilities can be derived from the directory of available resources. The directory of storage capabilities can be searchable by a user based on the directory of available resources. For example, a storage capability can be enabled when a resource capable of providing that storage capability is discovered by the crawler.

At block 614, resource provider information can be presented to a user. The resource provider information can be presented based on at least one of a policy criteria and a binding document. For example, the resource provider information can be presented based on an attribute of a resource associated with the resource provider that satisfies a set of policy criteria. For another example, the binding document, such as a service level agreement, can contain a plurality of storage capabilities and a deployment engine, such as deployment engine 112 of FIG. 1, can identify the storage capabilities of the binding document, and based on the map, a provisioner module, such as the provisioner module 444 of FIG. 4, can identify which resource provider (or combination of resource providers) can fulfill the storage capabilities.

Although the flow diagrams of FIGS. 4-6 illustrate specific orders of execution, the order of execution may differ from that which is illustrated. For example, the order of execution of the blocks may be scrambled relative to the order shown. Also, the blocks shown in succession may be executed concurrently or with partial concurrence. All such variations are within the scope of the present invention.

The present description has been shown and described with reference to the foregoing examples. It is understood, however, that other forms, details, and examples may be made without departing from the spirit and scope of the invention that is defined in the following claims.

What is claimed is:

1. A system comprising:
a spider engine to crawl a resource provider based on a configuration component, the configuration component to contain resource identification information and an interface associated with the resource provider;
a discovery engine to discover a resource of a resource provider based on the resource identification information;
an ontology engine to map the resource to an ontology term based on an infrastructure relationship identified by a cloud architect; and
a publication engine to provide the ontology term as part of resource directory, the resource directory to contain storage information associated with the resource of the resource provider.

2. The system of claim 1, wherein the publication engine is to:
maintain a dictionary of storage capabilities based on the resource discovered by the discovery engine, the dictionary to contain a plurality of available storage capabilities; and
associate an available storage capability with a resource provider based on the resource.

3. The system of claim 2, comprising:
a derivation engine to identify a derived capability based on the dictionary of storage capabilities.

4. The system of claim 3, wherein the derivation engine is to:
identify the ontology term from the resource directory is associated with a user-provided request for a resource based on the dictionary of storage capabilities.

5. The system of claim 1, comprising:
a deployment engine to map a first ontology to a second ontology, the first ontology to describe a workload based on an application and the second ontology to include the ontology term associated with the resource.

6. A computer readable medium comprising a set of instructions executable by a processor resource to:
receive a configuration from a cloud architect, the configuration to include an interface associated with a resource provider, resource identification information, and an ontology;
crawl the resource provider to discover a resource based on a template provided by the resource provider and the resource identification information;
map the resource to the ontology based on an infrastructure relationship provided by the cloud architect; and
publish a resource directory based on an ontology term associated with the resource available from the resource provider.

7. The medium of claim 6, wherein the set of instructions is executable by the processor resource to:
cause a storage capability to present to a user based on the resource directory.

8. The medium of claim 6, wherein the set of instructions is executable by the processor resource to:
receive a directory selection;
map the directory selection with the resource; and
provide information associated with the resource provider based on the resource.

9. The medium of claim 6, wherein the set of instructions is executable by the processor resource to:
provide a workload selection, the workload selection based on an application and resources associated with the storage capability for the application.

10. The medium of claim 6, wherein the set of instructions to crawl the resource provider is executable by the processor resource to at least one of:
periodically crawl the resource provider to maintain the resource directory; and
crawl the resource provider on-demand for storage capabilities to maintain the resource directory.

11. A method for providing resource information comprising:
configuring a crawler with an ontology and an interface associated with a resource provider;
crawling a network of storage mechanisms of the resource provider for a resource, the network of storage mechanisms accessible via the interface;
mapping the resource of the network of storage mechanisms to the ontology based on an infrastructure relationship of the resource discovered by the crawler; and
providing a directory of available resources based on the ontology and a map of the resources of the network of storage mechanisms.

12. The method of claim 11, comprising:
providing a directory of storage capabilities based on the ontology, the directory of storage capabilities searchable based on the directory of available resources.

13. The method of claim 11, comprising:
causing resource provider information to present to a user based on at least one of a set of policy criteria and a binding document, the binding document to contain a plurality of storage capabilities.

14. The method of claim 11, wherein storage mechanism is at least one of a virtual resource and a real storage resource.

15. The method of claim 12, comprising:
normalizing a first storage mechanism and a second storage mechanism based on the ontology, the first storage mechanism to provide the virtual resource and the second storage mechanism to provide the real storage resource.
